(19) United States
(12) Patent Application Publication
(10) Pub. No.: US 2012/0131214 A1
(43) Pub. Date: May 24, 2012

(54) RELAY APPARATUS, RELAY APPARATUS CONTROLLING METHOD, AND DEVICE CONTROLLER

(75) Inventors: Nobuyuki HONJO, Kawasaki (JP); Atsuhiro OTAKA, Kawasaki (JP)

(73) Assignee: FUJITSU LIMITED, Kawasaki-shi (JP)

(21) Appl. No.: 13/285,034

(22) Filed: Oct. 31, 2011

(30) Foreign Application Priority Data
Nov. 18, 2010 (JP) 2010-258165

(51) Int. Cl. G06F 15/16

(52) U.S. Cl. 709/228

(57) ABSTRACT

A relay apparatus includes a storing unit configured to store information related to a connection state between the relay apparatus and a device connected thereto, a determining unit configured to determine whether a change is a temporary change, based on a change factor responsible for the change in the connection state, in a case in which the change occurs in the connection state between the relay apparatus and the connected device. The relay apparatus includes a notifying unit configured to discontinue notifying a higher level apparatus of the change in the connection state when it is determined by the determining unit that the change in the connection state is a temporary change, and notify the higher level apparatus of the change in the connection state when it is determined by the determining unit that the change in the connection state is not a temporary change.

### CROSS-REFERENCE TO RELATED APPLICATION

This application is based upon and claims the benefit of priority of the prior Japanese Patent Application No. 2010-258165, filed on Nov. 18, 2010, the entire contents of which are incorporated herein by reference.

### FIELD

The embodiments discussed herein are related to a relay apparatus, a method of controlling a relay apparatus, and a device controller.

### BACKGROUND

Recently, storage devices and the like have employed Serial Attached SCSI (SAS) or Serial Advanced Technology Attachment (SATA) as standards for connecting devices such as hard disks. Relay apparatuses, such as expanders, that have physical ports compliant with such an SAS or SATA standard and that relay transmission and receiving of data between a higher-level apparatus and devices are known.

In cases where a change occurs in the state of the connected device because a device is removed and attached due to failure or for maintenance of the device, such a relay apparatus notifies a higher-level apparatus of the state change by broadcasting.

Specifically as illustrated in FIG. 13, when a change occurs in a link status indicating the connection state of a device (S1), a relay apparatus acquires information related to the connection from the device connected directly thereto (S2). Based on the acquired information, the relay apparatus updates a direct table (S3), and broadcasts a state change notification (S4).

Here the processing of the relay apparatus is described using an example illustrated in FIG. 14. For example, as exemplarily illustrated in FIG. 14, when a hard disk drive (HDD) “2-3” connected directly to an expander “#2”, which is a relay apparatus, fails, the link status between the expander “#2” and the HDD “2-3” shifts from “link up” to “link down”. The expander “#2” updates a direct table that stores information related to the connection state of devices connected directly to the expander “#2”, and issues a broadcast that notifies a higher-level expander “#1” of the change in the connection state.

Then, the expander “#1” that has received the notification acquires information related to the connection state held by the lower-level expander “#2”, and updates a direct table for the expander “#1” and a routing table that stores information related to the connection state between an expander lower in level than the expander “#1” and devices connected to the lower-level expander. The expander “#1” issues a broadcast notifying a higher-level expander “#0” of the state change. Thereafter, the expander “#0” acquires information related to the connection state held by the lower-level expander “#2”, and updates a direct table and a routing table, and notifies the ROC of the change in the connection state. Note that the direct table stores information related to the connection state between the expander addressed and devices connected directly thereto. The routing table stores information related to the connection state between a lower-level expander and devices connected thereto.

However, with the aforementioned technique of issuing a broadcast, a broadcast notifying a higher-level apparatus of information related to the connection state is issued every time a change occurs in the connection state of devices. This technique therefore has a problem in that resources such as a memory and a central processing unit (CPU) are wastefully consumed. In other words, even in cases in which a change in the connection state of devices is a temporary change and therefore a broadcast notifying a higher-level apparatus of information related to the connection state need not be issued, a broadcast is issued every time, which results in wasteful consumption of resources, such as a memory and a CPU, of a relay apparatus.

### SUMMARY

A relay apparatus for relaying data transmission between devices, the rely apparatus includes a storing unit configured to store information related to a connection state between the relay apparatus and a device connected thereto, a determining unit configured to determine whether a change in the connection state is a temporary change, based on a change factor responsible for the change in the connection state, in a case in which the change occurs in the connection state between the relay apparatus and the connected device, an updating unit configured to discontinue updating information related to the connection state stored in the first storing unit when it is determined by the determining unit that the change in the connection state is a temporary change, and update, based on the change in the connection state, the information related to the connection state stored in the first storing unit when it is determined by the determining unit that the change in the connection state is not a temporary change, and a notifying unit configured to discontinue notifying a higher level apparatus of the change in the connection state when it is determined by the determining unit that the change in the connection state is a temporary change, and notify the higher level apparatus of the change in the connection state when it is determined by the determining unit that the change in the connection state is not a temporary change.

The object and advantages of the invention will be realized and attained at least of the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a device control system according to a first embodiment.

FIG. 2 is a block diagram illustrating a configuration of an expander according to the first embodiment.

FIG. 3 is a block diagram illustrating a hardware configuration of an expander according to the first embodiment.

FIG. 4 illustrates an example of a direct table.

FIG. 5 illustrates an example of a routing table.

FIG. 6 is a table illustrating a link status change factor analyzing process.

FIG. 7 illustrates a comparison process and an updating process for the direct table.

FIG. 8 illustrates an example of the direct table after the connection state has been changed.

FIG. 9 illustrates a comparison process and an updating process for the routing table.

FIG. 10 illustrates an example of the routing table after the connection state has been changed.

FIG. 11 is a flowchart for illustrating the procedure of a process of updating a direct table of an expander according to the first embodiment.

FIG. 12 is a flowchart for illustrating the procedure of a process of updating a routing table of the expander according to the first embodiment.

FIG. 13 is a flowchart for illustrating the procedure of a process of updating a direct table of a conventional expander.

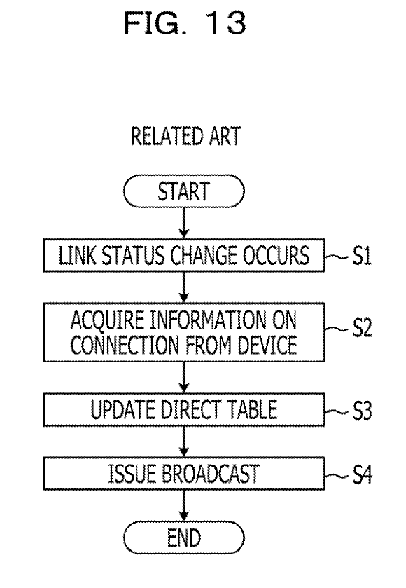

FIG. 14 illustrates an example of the case in which failure occurs in a device.

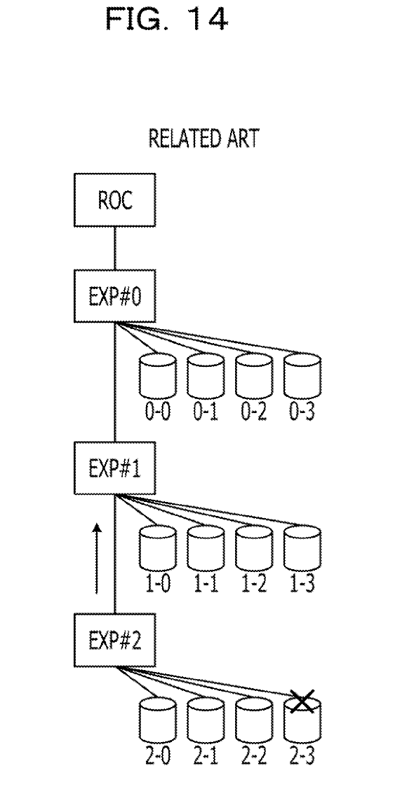

### DESCRIPTION OF THE EMBODIMENTS

Preferred embodiments of a relay apparatus, a relay method and a device controller according to this technique is described in detail below with reference to the accompanying drawings.

### First Embodiment

### [Configuration of Expander]

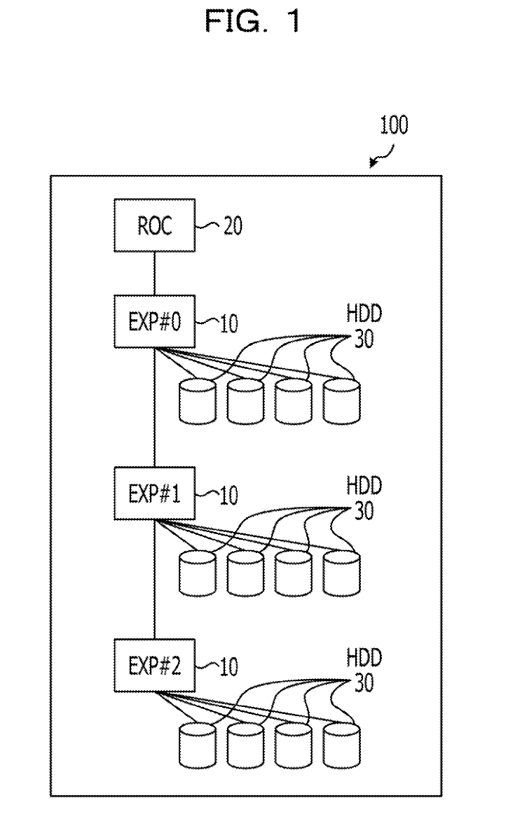

The configuration of a device control system including expanders according to a first embodiment is described with reference to FIG. 1. FIG. 1 is a block diagram illustrating a configuration of the device control system. As illustrated in FIG. 1, a device control system 100 includes a plurality of expanders 10, a RAID-on-Chip (ROC) 20, and a plurality of hard disk drives (HDDs) 30. The device control system is, for example, a Redundant Arrays of Inexpensive Disks (RAID) device.

Each expander 10 is connected to the HDDs 30, which are devices compliant with the SAS or SATA standard, and controls data communications carried out between the expander 10 and the HDDs 30. Each expander 10 also notifies a higher-level expander 10 or a ROC 20 of various events that have occurred in the HDDs 30 connected directly to that expander 10. For example, using an example illustrated in FIG. 1, an expander “EXP#2” notifies a higher level expander “EXP#1” of various events that have occurred in the HDDs 30 connected directly to the expander “EXP#2”. An expander “EXP#0”, the highest-level expander, notifies the ROC 20 of various events that have occurred in the HDDs 30.

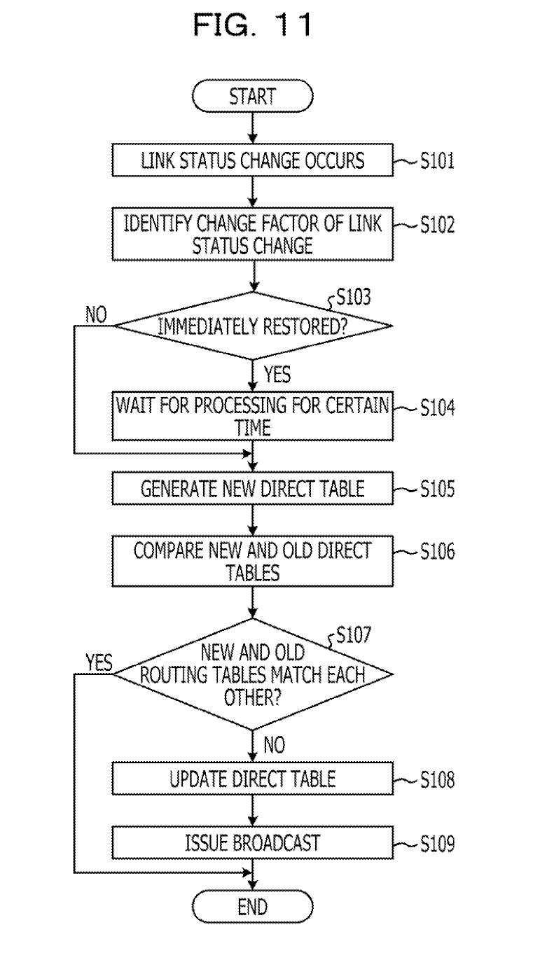

The ROC 20 is connected to the highest-level expander EXP#0 and is a device that controls the entirety of the expanders 10 and executes an instruction received from a server (not illustrated). For example, upon accepting a data acquisition instruction from a server, the ROC 20 acquires data through the expanders 10 from the HDD 30 and transmits the acquired data to the server. The ROC 20 holds information related to the connection states of the HDDs 30 as a routing table (to be described in detail later with reference to FIG. 11). The HDDs 30 may be, for example, devices connected to the expander 10 and are hard disks compliant with the SAS or SATA standard.

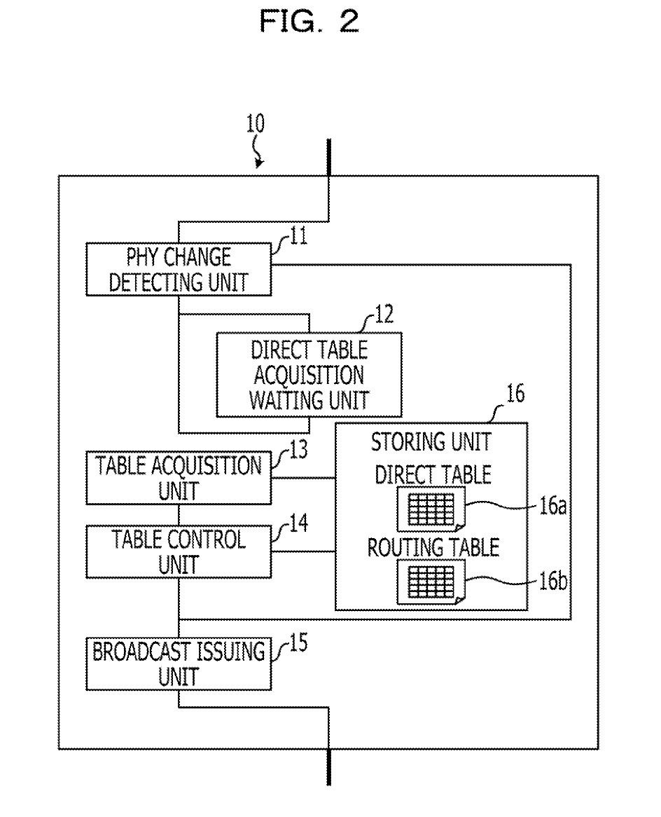

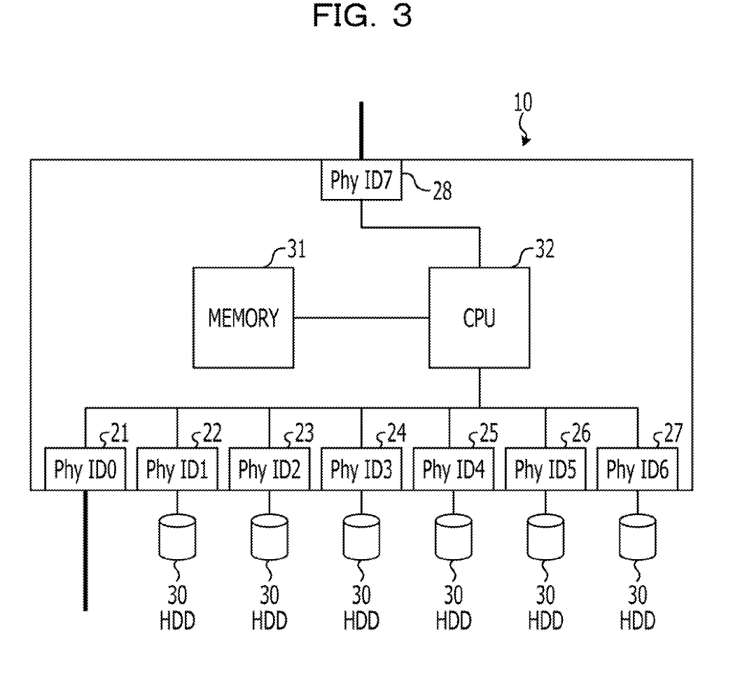

Next, with reference to FIG. 2, the configuration of the expander 10 illustrated in FIG. 1 is described. FIG. 2 is a block diagram illustrating a configuration of an expander according to the first embodiment. The expander 10 includes a PHY change detecting unit 11, a direct table acquisition waiting unit 12, a table acquisition unit 13, a table control unit 14, a broadcast issuing unit 15, and a storing unit 16. Before the description of processing of these units, the hardware configuration of the expander 10 is described with reference to FIG. 3. FIG. 3 is a block diagram illustrating a hardware configuration of an expander according to the first embodiment. As illustrated in FIG. 3, the expander includes physical layers (Phys) 21 to 28, a memory 31, and a CPU 32.

The Phys 21 to 28 are physical ports compliant with a SAS or SATA standard, and each connects the expander 10 and another device through a bus. Specifically, the Phys 22 to 27 are connected to the HDDs 30, which are devices connected to the expander 10, the Phy 21 is connected to the expander 10 which is lower in level than the expander 10 addressed, and the Phy 28 is connected to an expander which is higher in level than the expander 10 addressed or the ROC 20.

The CPU 32 loads the memory 31 with firmware and performs processing for the PHY change detecting unit 11, the direct table acquisition waiting unit 12, the table acquisition unit 13, the table control unit 14, and the broadcast issuing unit 15, which are described later. In the memory 31, firmware used for various processing is loaded, and a direct table 16a and a routing table 16b described later are stored.

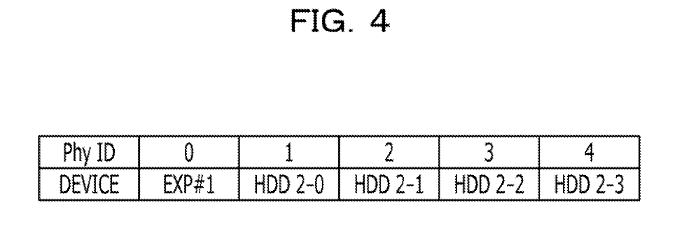

With reference back to FIG. 2, the units described. As illustrated in FIG. 2, the storing unit 16 stores the direct table 16a and the routing table 16b. The direct table 16a stores information related to the connection state between the expander addressed and devices connected directly thereto. Specifically, as exemplarily illustrated in FIG. 4, the direct table 16a stores “Phy ID”, which is an identifier uniquely given to each physical port of the expander 10, and “Device” indicating information related to a device connected to the physical port in such a manner that they are associated with each other. FIG. 4 illustrates an example of the direct table.

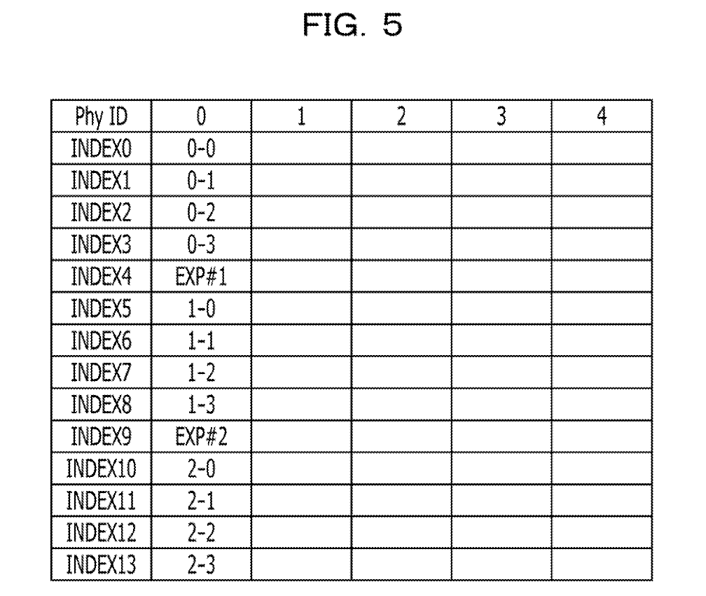

The routing table 16b stores information related to the connection state between lower-level expanders and devices connected thereto. Specifically, as exemplarily illustrated in FIG. 5, the routing table 16b stores “Phy ID” indicating identifiers uniquely given to physical ports and information related to all devices indirectly connected through the physical ports. In an example of FIG. 5, fourteen devices listed with Indexes 0 to 13 are connected to a physical port indicated by Phy ID “0”. The example also shows that no devices are connected to physical ports indicated by Phy IDs “1” to “4”.

In the case in which a change occurs in the connection state between the expander addressed and a device connected thereto, the PHY change detecting unit 11 determines, based on a change factor responsible for the change in the connection state, whether the change in the connection state is a temporary change. Specifically, the PHY change detecting unit 11 detects whether the connection state of the device connected to the expander addressed has changed. If the PHY change detecting unit 11 detects that the connection state of the device connected to the expander addressed has changed, the PHY change detecting unit 11 identifies the change factor responsible for the change in the connection state, and determines, based on the change factor, whether the change in the connection state is a temporary change.

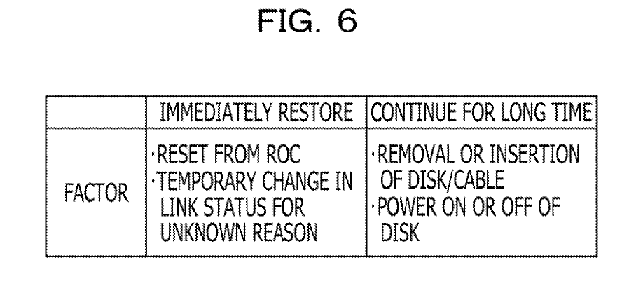

Here, with reference to FIG. 6, a process to determine whether the change in the connection state is a temporary change is specifically described. FIG. 6 is a table illustrating a link status change factor analyzing process. As exemplarily illustrated in FIG. 6, in the case in which reset processing from the ROC 20 is the change factor responsible for the change, the PHY change detecting unit 11 determines that the change in the connection state is a temporary change and the connection state is restored. This is because that, in the case in which the connection state between the expander 10 and the device connected thereto is reset, for example, by reset processing from the ROC 20, the connection state is typically restored to that prior to the resetting in about 100 ms. In the case in which a sudden change in the link status, the cause of which is unknown, is the factor responsible for the change, the PHY change detecting unit 11 determines that the change in the connection state is a temporary change and the connection state is restored.

In the case in which the PHY change detecting unit 11 detects, for example, from mount information that removal or insertion of a disk or a cable is the change factor, and in the case in which powering off or on of a device is the change factor, the PHY change detecting unit 11 determines that the change in the connection state is not a temporary change and the change may continue for a long time.

In the case in which a notification of a change in the connection state is received from a lower-level expander by broadcasting, the PHY change detecting unit 11 notifies the table acquisition unit 13 of the receipt of a broadcast.

If, based on the change factor, it is determined that the change in the connection state is a temporary change, the direct table acquisition waiting unit 12 waits, for a certain time, for processing of generating a direct table to be performed. Specifically, the direct table acquisition waiting unit 12 provides a timer by firmware processing so that the processing of a direct table is controlled, wait for a certain period.

The table acquisition unit 13 acquires the direct table 16a from the storing unit 16 in the case in which the connection state between the expander addressed and devices connected thereto changes. In the case in which a notification of a change in the connection state is received as a broadcast from a lower-level expander, the table acquisition unit 13 acquires the routing table 16b from the lower-level apparatus and acquires the routing table 16b from the storing unit 16 of the expander addressed.

Specifically, in the case in which a change occurs in the connection state between the expander addressed and the HDD 30, which is a device connected to the expander addressed, the table acquisition unit 13 acquires information from the device connected to the expander addressed, generates a new direct table that reflects the acquired information and causes the storing unit 16 to store the new direct table. Here, a new direct table is generated, and, at substantially the same time, the old direct table that does not reflect information related to the current connection state is held in the storing unit 16. This is because the table control unit 14 described later compares new and old direct tables.

Upon receiving, from the PHY change detecting unit 11, a notification to the effect that the notification has been received by broadcasting, the table acquisition unit 13 acquires the routing table 16b from a lower-level expander and acquires the routing table 16b from the storing unit 16 of the expander addressed.

If the change in the connection state is a temporary change, then the table control unit 14 discontinues updating information related to the connection state stored in the direct table 16a and the routing table 16b. By contrast, if the change in the connection state is not a temporary change, then, based on the change in the connection state, the table control unit 14 updates information related to the connection states stored in the direct table 16a and the routing table 16b.

Specifically, in the case in which a change occurs in the connection state between the expander addressed and the HDD 30, which is a device connected to the expander addressed, the table control unit 14 compares an old direct table acquired from the storing unit by the table acquisition unit 13 with a new direct table in which information related to the current connection status is reflected by the table acquisition unit 13. As a result, if the new and old direct tables match, the table control unit 14 discontinues updating information related to the connection state stored in the direct table 16a and maintains the direct table 16a stored in the storing unit 16 as the old direct table. If the new and old direct tables do not match each other, the table control unit 14 updates the direct table 16a stored in the storing unit 16 to the new direct table.

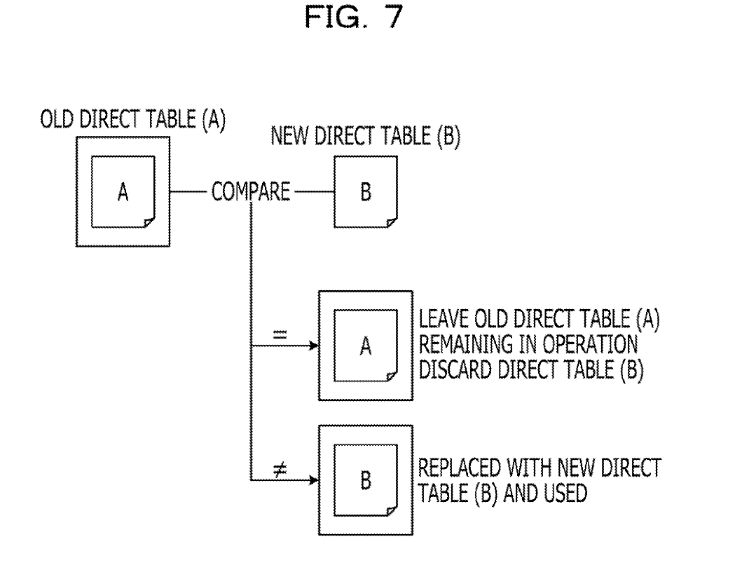

Here, with reference to FIG. 7, a comparison process and an updating process for a direct table is described. FIG. 7 illustrates a comparison process and an updating process for a direct table. As illustrated in FIG. 7, the table control unit 14 compares an old direct table A currently in operation and a new direct table B. If all the contents of the tables match, the old direct table A remains in operation and the new direct table B is discarded. If no contents of the tables match, the table control unit 14 replaces the direct table 16a of the storing unit 16 with the new direct table B, and the new direct table B is used in the subsequent operation.

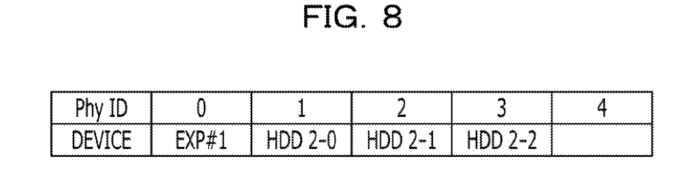

The comparison process is described using an example in which it is assumed that the direct table exemplarily illustrated in FIG. 4 is the old table and the direct table exemplarily illustrated in FIG. 8 is the new table. FIG. 8 illustrates an example of a direct table after the connection state has changed. As illustrated in FIG. 8, in the new direct table exemplarily illustrated in FIG. 8, a device “HDD 2-3” is not connected to the physical port indicated by Phy ID “4”, as compared to the old direct table exemplarily illustrated in FIG. 4. For this reason, the table control unit 14 determines that the contents of the tables do not match when comparing the old direct table A being currently used with the new direct table B, and replaces the direct table 16a of the storing unit 16 with the new direct table B.

In the case in which the table control unit 14 receives a notification of a change in the connection state from a lower-level expander by broadcasting, the table control unit 14 compares an old routing table acquired from the storing unit by the table acquisition unit 13 with a new routing table in which information related to the current connection status is reflected by the table acquisition unit 13. As a result, if the new and old routing tables match, the table control unit 14 discontinues updating information related to the connection state stored in the routing table 16b and maintains the routing table 16b stored in the storing unit 16 as of the old routing table. If the new and old routing tables do not match, the table control unit 14 updates the routing table 16b stored in the storing unit 16 to the new routing table.

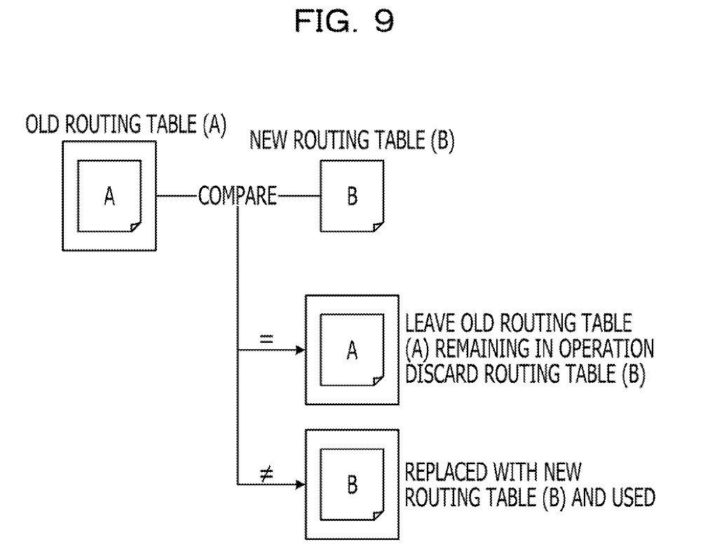

Here, with reference to FIG. 9, a comparison process and an updating process for the routing table is described. FIG. 9 illustrates a comparison process and an updating process for the routing table. As illustrated in FIG. 9, the table control unit 14 compares an old routing table A currently in operation with a new routing table B. If all the contents of the tables match, the old routing table A remains in operation and the new routing table B is discarded. If no contents of the tables match, the table control unit 14 replaces the routing table 16b of the storing unit 16 with the new routing table B, and the new routing table B is used in the subsequent operation.

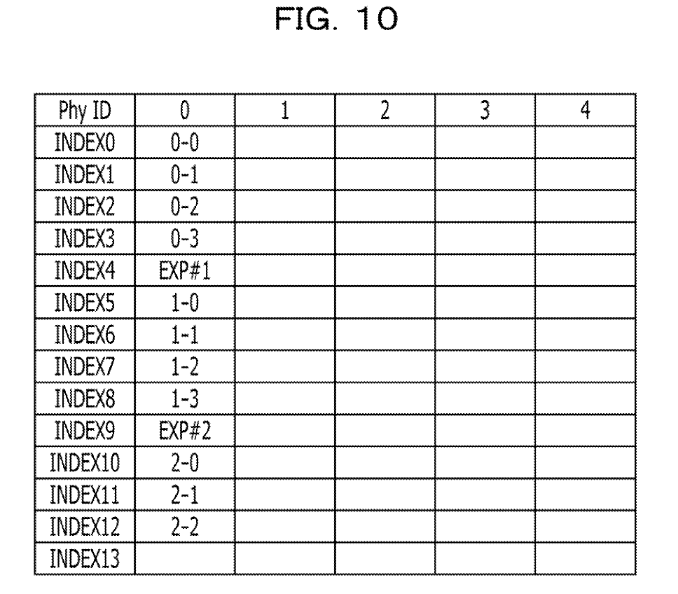

The comparison process is described using an example in which it is assumed that the routing table exemplarily illustrated in FIG. 10 is the old table and the routing table exemplarily illustrated in FIG. 5 is the new table. FIG. 10 illustrates an example of a routing table after the connection state has changed. In the new routing table exemplarily illustrated in FIG. 10, the device “HDD 2-3” is not listed with an index associated with Phy ID “0”, as compared to the old routing table exemplarily illustrated in FIG. 5. For this reason, the table control unit 14 determines that the contents of the tables do not match when comparing the old routing table A being currently used with the new routing table B, and replaces the routing table 16b of the storing unit 16 with the new routing table B.

If it is determined that the change in the connection state is a temporary change, the broadcast issuing unit 15 discontinues issuing a broadcast to the expander 10 higher in level than the expander addressed or the ROC 20. In the case in which it is determined that the change in the connection state is not a temporary change, the broadcast issuing unit 15 issues a broadcast to the higher-level expander 10 or the ROC 20.

Specifically, if it is determined by the table control unit 14 that new and old direct tables or new and old routing tables do not match, the broadcast issuing unit 15 issues a broadcast to the higher-level expander 10 or the ROC 20.

### [Processes Performed by Expander]

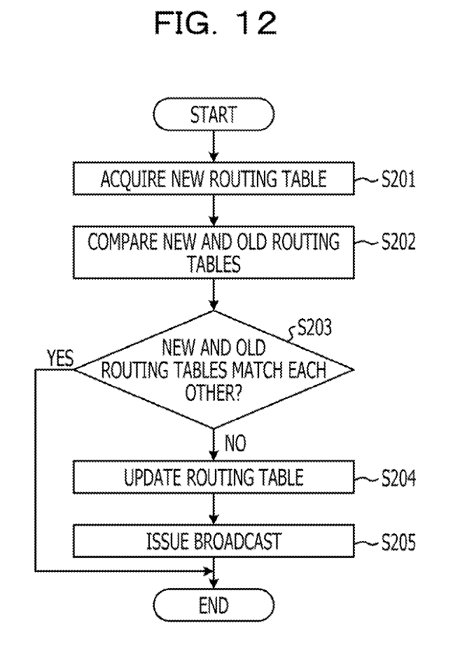

Next, with reference to FIG. 11 and FIG. 12, processes to be performed by the expander 10 according to the first embodiment are described. FIG. 11 is a flowchart illustrating the procedure of a process of updating a direct table of an expander according to the first embodiment. FIG. 12 is a flowchart illustrating the procedure of a process of updating a routing table of an expander according to the first embodiment.

As illustrated in FIG. 11, when a change occurs in a link status indicating the connection state of a device addressed (S101), the PHY change detecting unit 11 of the expanders 10 identifies the factor responsible for the change in the link status (S102). Based on the identified change factor, the PHY change detecting unit 11 determines whether the change in the link status results in immediate restoration of the link status (S103).

As a result, if the PHY change detecting unit 11 determines that the change in the link status does not result in immediate restoration of the link status (No in S103), the table acquisition unit 13 generates a new direct table (S105). If the PHY change detecting unit 11 determines that the change in the link status results in immediate restoration of the link status (Yes in S103), the table acquisition unit 13 waits for a specified time (S104) and generates a new direct table (S105). Here, as generating a new direct table, the table acquisition unit 13 acquires information related to the current connection state from a device connected to the expander addressed, and generates a new direct table that reflects the acquired information related to the current connection status.

The table control unit 14 compares an old direct table acquired from the storing unit by the table acquisition unit 13 with a new direct table in which information related to the current connection status is reflected by the table acquisition unit 13 (S106). As a result, if the new and old direct tables match (Yes in S107), the table control unit 14 discontinues updating the direct table 16a and issuing a broadcast, and the table control unit 14 ends the flow. If the new and old direct tables do not match (No in S107), the table control unit 14 updates the direct table 16a stored in the storing unit 16 to the new direct table (S108). The broadcast issuing unit 15 issues a broadcast to the higher-level expander 10 or the ROC 20 (S109).

Next, with reference to FIG. 12, a process in which the expander 10 updates the routing table is described. As illustrated in FIG. 12, the PHY change detecting unit 11 of the expander 10 receives a notification of the change in the connection state from a lower-level expander by broadcasting. The table acquisition unit 13 acquires the routing table (hereinafter referred to as a “new routing table”) 16b from a lower-level expander, and acquires the routing table (hereinafter referred to as an “old routing table”) 16b from the storing unit 16 of the expander addressed (S201).

The table control unit 14 compares the old routing table with the new routing table (S202). As a result, if the new and old routing tables match (Yes in S203), the table control unit 14 discontinues updating the routing table 16b and issuing a broadcast to a higher-level device, and the table control unit 14 ends the flow.

If the new and old routing tables do not match (No in S203), the table control unit 14 updates the routing table 16b stored in the storing unit 16 to the new routing table (S204). The broadcast issuing unit 15 issues a broadcast to the higher-level expander 10 or the ROC 20 (S205).

### [Effects of First Embodiment]

As described above, in the case in which a change occurs in the connection state between the expander 10 and a device connected thereto, that expander 10 determines, based on the change factor responsible for the change in the connection state, whether the change in the connection state is a temporary change. If it is determined that the change in the connection state is a temporary change, the expander 10 discontinues updating information related to the connection state stored in the direct table 16a. If it is determined that the change in the connection state is not a temporary change, the expander 10 updates information related to the connection state stored in the direct table 16a, based on the change in the connection state. The expander 10 discontinues notifying an apparatus higher in level than the expander 10 of the change in the connection state if it is determined that the change in the connection state is a temporary change, whereas the expander 10 notifies the higher-level apparatus of the change in the connection state if it is determined that the change in the connection state is not a temporary change. This can reduce or prevent resources of the expander 10 from being wastefully consumed.

In other words, in the case in which a change occurs in the connection state between the expander 10 and a device, the expander 10 determines from the change factor whether the change in the connection state is not a temporary change, and discontinues issuing a broadcast if the change is a temporary change. Wasteful consumption of resources of the expander 10 can therefore be reduced or prevented.

According to the first embodiment, the expander 10 identifies whether the change factor responsible for the change in the connection state is a reset from a higher-level apparatus, removal or insertion of a cable, or powering on or off, and, depending on the identified change factor, the expander 10 determines whether the change in the connection state is a temporary change. Therefore, whether the change in the connection state is a temporary change can be appropriately determined from the change factor responsible for the change in the connection state of a device. This can appropriately reduce or prevent resources of the expander 10 from being wastefully consumed.

According to the first embodiment, the expander 10 includes the routing table 16b storing information related to the connection state between an apparatus lower in level than that of expander 10 and a device connected to the lower-level apparatus. Upon receiving a notification of a change in the connection state from the lower-level apparatus by broadcasting, the expander 10 requests information related to the connection state held by the lower-level apparatus and acquires the information related to the connection state. The expander 10 compares the acquired information related to the connection state that is held by the lower-level apparatus with information related to the connection state between the apparatus lower in level than that expander 10 and a device connected to the lower-level apparatus that is stored in the storing unit 16. The expander 10 discontinues updating information related to the connection state stored in the routing table 16b if the acquired information and the stored information match as a result of comparison, whereas the expander 10 updates information related to the connection state stored in the routing table 16b if the acquired information and the stored information do not match. The expander 10 discontinues notifying an apparatus higher in level than that expander 10 of the change in the connection state if the acquired information and the stored information match as a result of comparison, whereas the expander 10 notifies the higher-level apparatus of the change in the connection state if the acquired information and the stored information do not match. As a result, if there is no change in the routing table 16b before and after the receipt of a broadcast, the expander 10 discontinues issuing a broadcast. Consequently, wasteful consumption of resources of the expander 10 can be appropriately reduced or prevented.

### Second Embodiment

The embodiment of the technique has been described above; however, it is to be understood that the technique may be embodied in various forms other than the foregoing embodiment. Another embodiment included in the technique is described as a second embodiment hereinbelow.

### (1) System Configuration and the Like

The constituent elements of apparatuses illustrated in the drawings are functionally conceptual, and need not be physically configured as illustrated. In other words, specific forms of distribution and integration of the apparatuses are not limited to those illustrated in the drawings, and all or part thereof may be functionally or physically distributed and integrated in arbitrary units in accordance with various loads and the status of use. For example, the table acquisition unit 13 and the table control unit 14 may be integrated. Further, all or an arbitrary part of processing functions to be performed in the apparatuses may be implemented by a CPU and programs to be analyzed and executed by the CPU, or may be implemented as hardware by wired logic.

### (2) Program

It is to be noted that the relay method described in this embodiment may be implemented by executing a prepared program on a computer such as a personal computer or a workstation. The program may be distributed over a network such as the Internet. Moreover, the program may be recorded on a computer-readable recording medium such as a hard disk, a flexible disk (FD), a compact disk-read only memory (CD-ROM), a magneto-optical (MO) disk or a digital versatile disk (DVD), and be read from the recording medium by the computer so that the program is executed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay apparatus for relaying data transmission between devices, the rely apparatus comprising:
a storing unit configured to store information related to a connection state between the relay apparatus and a device connected thereto;
a determining unit configured to determine whether a change in the connection state is a temporary change, based on a change factor responsible for the change in the connection state, in a case in which the change occurs in the connection state between the relay apparatus and the connected device;
an updating unit configured to discontinue updating information related to the connection state stored in the first storing unit when it is determined by the determining unit that the change in the connection state is a temporary change, and update, based on the change in the connection state, the information related to the connection state stored in the first storing unit when it is determined by the determining unit that the change in the connection state is not a temporary change; and
a notifying unit configured to discontinue notifying a higher level apparatus of the change in the connection state when it is determined by the determining unit that the change in the connection state is a temporary change, and notify the higher level apparatus of the change in the connection state when it is determined by the determining unit that the change in the connection state is not a temporary change.

2. The relay apparatus according to claim 1, wherein the determining unit identifies whether the change factor responsible for the change in the connection state is a reset from a higher level apparatus, removal or insertion of a cable, or powering on or off, and, depending on the identified change factor, determines whether the change in the connection state is a temporary change.

3. The relay apparatus according to claim 1, further comprising:
a second storing unit configured to store information related to a connection state between a lower level apparatus and a device connected to the lower level apparatus;
an acquisition unit configured to, when receiving a notification of a change in the connection state from the lower level apparatus, requests information related to the connection state, the information being held by the lower level apparatus, and acquires the information related to the connection state; and
a comparison unit configured to compare the information related to the connection state held by the lower level apparatus, the information being acquired by the acquisition unit, with the information related to the connection state between the lower level apparatus and the device connected to the lower level apparatus, the information being stored in the second storing unit, wherein
the updating unit discontinues updating information related to the connection state stored in the second storing unit when the acquired information and the stored information match each other as a result of comparison by the comparison unit, and updates information related to the connection state stored in the second storing unit when the acquired information and the stored information do not match, and
the notifying unit discontinues notifying a higher level apparatus of the change in the connection state when the acquired information and the stored information match each other as a result of comparison by the comparison unit, and notifies the higher level apparatus of the change in the connection state when the acquired information and the stored information do not match.

4. A method of controlling a relay apparatus for relaying data transmission between devices, the method comprising:
determining, based on a change factor responsible for a change in the connection state, whether the change in a connection state is a temporary change, in a case in which the change occurs in the connection state between the relay apparatus and a device connected thereto;
discontinuing updating of information related to the connection state stored in the first storing unit, the storing unit storing the information related to the connection state between the relay apparatus and the device connected thereto, when it is determined that the change in the connection state is a temporary change, and updating, based on the change in the connection state, the information related to the connection state stored in the first storing unit when it is determined that the change in the connection state is not a temporary change; and
discontinuing notifying of a higher level apparatus of the change in the connection state when it is determined that the change in the connection state is a temporary change, and notifying the higher level apparatus of the change in the connection state when it is determined that the change in the connection state is not a temporary change.

5. A device controller including a device and a relay apparatus connected with the device, the device comprising:
a storing unit configured to store information related to a connection state between the relay apparatus and a device connected thereto;
a determining unit configured to determine, based on a change factor responsible for a change in the connection state, whether the change in the connection state is a temporary change, in a case in which the change occurs in the connection state between the relay apparatus and the connected device;
an updating unit configured to discontinue updating information related to the connection state stored in the first storing unit when it is determined by the determining unit that the change in the connection state is a temporary change, and update, based on the change in the connection state, the information related to the connection state stored in the first storing unit when it is determined by the determining unit that the change in the connection state is not a temporary change; and
a notifying unit configured to discontinue notifying a higher level apparatus of the change in the connection state when it is determined by the determining unit that the change in the connection state is a temporary change, and notify the higher level apparatus of the change in the connection state when it is determined by the determining unit that the change in the connection state is not a temporary change.

6. A device controller including a device and a relay apparatus connected with the device, the device comprising:
a storing unit configured to store information related to a connection state between the relay apparatus and a device connected thereto; and
a processor configured to:
determine whether a change in the connection state is a temporary change, in a case in which the change occurs in the connection state between the relay apparatus and the connected device, based on a change factor responsible for the change in the connection state;
discontinue updating information related to the connection state stored in the storing unit when it is determined by the determining unit that the change in the connection state is a temporary change, and update, based on the change in the connection state, the information related to the connection state stored in the first storing unit when it is determined by the determining unit that the change in the connection state is not a temporary change; and
discontinue notifying a higher level apparatus of the change in the connection state when it is determined by the determining unit that the change in the connection state is a temporary change, and notify the higher level apparatus of the change in the connection state when it is determined by the determining unit that the change in the connection state is not a temporary change.
